(19) United States
(12) Patent Application Publication
(10) Pub. No.: US 2018/0126325 A1
(43) Pub. Date: May 10, 2018

(54) Method Apparatuses Assemblies and Systems for Dehumidifying Air and Producing Water

(71) Applicant: Abe M. Sher, Surfside, FL (US)

(72) Inventor: Abe M. Sher, Surfside, FL (US)

(21) Appl. No.: 15/626,448

(22) Filed: Jun. 19, 2017

Related U.S. Application Data
(60) Provisional application No. 62/351,982, filed on Jun. 19, 2016.

(51) Int. Cl. B01D 53/14; E03B 3/28; B01D 53/26

(52) U.S. Cl. CPC B01D 53/1425; E03B 3/28; B01D 53/265; B01D 53/1418; B01D 53/263

(57) ABSTRACT

Disclosed are methods, apparatuses, assemblies and systems for dehumidifying air and producing water. According to some embodiments, there may be provided a system including: (a) a desiccant reservoir to hold hydrated desiccant received through a pumped line from a functionally associated moisture-collection or dehumidification chamber, and (b) a passive desiccant return line connected to an outlet of said desiccant reservoir of said regeneration chamber and configured to provide for self-regulated desiccant flow from said desiccant reservoir of said regeneration chamber back to the moisture-collection/dehumidification chamber.

### RELATED APPLICATIONS

This application claims the priority of applicant's U.S. Provisional Patent Application No. 62/351,982, filed Jun. 19, 2016. The disclosure of the above mentioned 62/351,982, Provisional patent application, is hereby incorporated by reference in its entirety for all purposes.

### FIELD OF THE INVENTION

The present invention relates generally to the field of air dehumidification and water extraction/production from air. More specifically, the present invention relates to methods, apparatuses, assemblies and systems for dehumidifying air and water production.

### BACKGROUND

The Incas were able to sustain their culture above the rain line by collecting dew and channeling it to cisterns for later distribution. Historical records indicate the use of water-collecting fog fences. Several inventors have developed air wells as a way to passively collect moisture from air. Although these traditional methods have usually been completely passive, requiring no external energy source(s) other than naturally occurring temperature variations, water production output of such systems has been limited, uncontrollable and predictable.

A devices or systems which produces water from humidity in the air is commonly referred to as atmospheric water generators (AWG). AWGs are especially useful where pure drinking water is difficult or impossible to obtain, but there is a small amount of water in the air that can be extracted. With the supplies of potable water in various regions of world drying up, the past few decades has seen a rise in investment to develop more modern and effective AWG water extraction technologies. This investment has resulted in the development of various AWG technologies based on a variety of different extraction processes. In most AWG's, water vapor in air is extracted either by: (a) condensation through cooling the air below its dew point, (b) exposing the air to desiccants, or (c) pressurizing the air. Unlike a basic air dehumidifier, an AWG is specifically designed to render the extracted water in a potable form.

FIG. 1 shows an exemplary condensation based AWG system according to the prior art, including an air mover (fan), chilling evaporators to cool the air, and a collected water reservoir, among other elements required to extract and provide potable water from air. This is the most common technology in use, and it operates in a manner very similar to that of a dehumidifier: air is passed over a cooled coil, causing water to condense. The rate of water production depends on the ambient temperature, humidity, the volume of air passing over the coil, and the machine's capacity to cool the coil. These types of systems reduce air temperature, which in turn reduces the air's capacity to carry water vapor. A major drawback of these types of systems is the amount of energy required to power the cooling elements of the system.

Although AWG methods which are completely passive, relying on natural temperature differences, and requiring no external energy source, may be relatively inexpensive to operate, extraction of atmospheric water using active chilling and/or condensing methods and technologies is not free of cost due to significant energy requirements to drive some AWG processes, for example in conditions where ambient air humidity is very low relatively large amounts of energy are required to move, cool and/or compress large volumes of air to extract relatively small amounts of water.

Some alternative AWG technologies use liquid, or “wet” desiccants such as lithium chloride or lithium bromide to pull water from the air via hygroscopic processes. Regeneration of water saturated liquid desiccant, that is removing water from the desiccant, can generate water in most climates more efficiently than most other known technologies known today. One form of wet desiccant water generation involves the use of salt in a concentrated brine solution to absorb the ambient humidity. These systems then extract the water from the solution and purify it for consumption. A version of this technology was developed as a portable device which can run on generators. Large versions, mounted on trailers, are said to produce up to 1,200 US gallons (4,500 l) of water per day.

A common issue with all of today's AWG technologies and systems is size, more specifically are often issues with the large overall volume and footprints of many AWG systems require to produce meaningful amounts of water. Large scale AWG systems, both passive and active, require a considerable volume of space and footprint, which requirement may be functionally prohibitive under certain conditions and in certain locations. A drawback specific to liquid desiccant regeneration based water production systems is the large volume or space required for the processes of: (a) collecting moisture from the air by the desiccant, and (b) regenerating the desiccant by evaporating from it water for condensation and collection, each of which processes requires a separate chamber which are placed side by side. Prior art systems require the two chambers to be side by side, thus resulting in a large footprint.

There is a need for improved methods, devices and systems for dehumidifying air and producing water.

### SUMMARY OF THE INVENTION

The present invention includes method, apparatuses, assemblies and systems for dehumidifying air and producing water from the moisture extracted from the air. According to some embodiments a liquid desiccant based air dehumidifying assembly or chamber, also referable to as a moisture collection assembly or chamber, may be positioned somewhere relatively lower than a corresponding desiccant regeneration assembly or chamber, which regeneration assembly may also be referred to as a water-extraction assembly or chamber. According to embodiments, liquid desiccant which absorbed moisture from air in the dehumidifying/moisture-collection assembly may be pumped up into the regeneration/water-extraction assembly. After being regenerated, desiccant from which moister/water was extracted in the regeneration assembly may return back to the dehumidifying/moisture-collection assembly by flowing down a return line, tube or pipe, for example a capillary tube return line. The terms line, tube and/or pipe, along with functionally equivalent structures, may be used interchangeably for purposes of this disclosure. The return flow may be a passive self-regulating return flow, which self-regulating return flow rate may be a function of, among other things, desiccant viscosity, which viscosity may be a function of desiccant hydration. Terms self-regulating and self-regulated may be used interchangeably for purposes of this application.

According to some embodiments, fluid flow of hydrated desiccant from the lower dehumidification chamber to the upper regeneration chamber may be triggered by an output signal from a desiccant volume or level sensor functionally associated with a desiccant reservoir of the dehumidification chamber. For example, once a desiccant level in the dehumidification chamber reservoir exceeds a certain level, desiccant flow from the lower chamber to the up chamber may be triggered. A desiccant level in the dehumidification chamber reservoir dropping below a certain level may trigger a cessation of desiccant flow to the regeneration chamber. A desiccant level in the dehumidification chamber reservoir dropping below a certain level may trigger an increase in desiccant hydration flows through dehydration chamber, wherein desiccant hydration flows may include: (a) airflow through the dehydration chamber; and (b) desiccant misting (e.g. spraying mist) through the air flowing in the dehydration chamber.

Hydrated or partially hydrated desiccant pumped into the regeneration chamber may be collected in a regeneration chamber desiccant reservoir. A misting mechanism within the regeneration chamber may spray hydrated desiccant mist through an air stream directed towards chilled condensation coils, which coils may be located over a water collection pan. An outlet of the pan may lead to a fresh water reservoir. As water is removed from the regeneration reservoir desiccant, it becomes dehydrated or regenerated and may be returned to the dehumidification chamber through a return channel or line, for example one or more capillary type tubes, lines or pipes, which may be referred to as capillary tubes.

According to some embodiments, regenerated liquid desiccant, from which some water has been evaporated, may return to the reservoir in the dehumidifying/moisture-collection assembly via one or more capillary tubes, pushed downward by the force of gravity. A phenomenon called “capillary action” produced by an interplay between the adhesion on the inner surface of the capillary tube and the viscosity of the liquid desiccant may under some conditions counter some or all of the force of gravity pushing the desiccant downward towards the dehumidifying/moisture-collection assembly, thereby slowing or completely stopping the regenerated liquid desiccant flow into the dehumidification chamber. The capillary tube may be selected, configure and/or designed (i.e. selecting a length, an internal diameter and/or an angle) such that at a specific viscosity the force due to capillary action is sufficient to fully counter the force of gravity and the return flow of liquid desiccant back to the dehumidifying/moisture-collection assembly is stopped. At a certain desiccant viscosity threshold of the desiccant in the regenerator, the liquid desiccant will be blocked from being returned to the dehumidifier/moisture-collection assembly. Since the viscosity of liquid desiccant increases as water is removed from it, the capillary tube configuration (e.g. diameter, length and/or angle) may be selected to fully counter the force of gravity and stop the return flow of liquid desiccant back to the dehumidifying/moisture-collection assembly when the hydration level or percentage of desiccant in the regeneration chamber falls below a predefined level which results in a rise of the desiccant viscosity towards a predefined viscosity level sufficient to produce a capillary action force equal or greater than the force of gravity.

The bidirectional desiccant flow configuration of the present invention, pumping hydrated desiccant and controlled passive return of dehydrated/regenerated desiccant, may be designed and configured such that when the regeneration process rate exceeds the moisture collection process rate, there will be enough pressure on the capillary tube to reduce or temporarily stop return of regenerated or dry liquid desiccant from the regeneration chamber to the dehumidification chamber. If the liquid desiccant level in the dehumidification/moisture-collection chamber drops, due to a slowing or stoppage of desiccant return, the forced or pumped transfers of liquid desiccant to the regeneration chamber may also be stopped, for example by closing an electrically controlled valve, until enough water is collected by the dehumidifier desiccant for the desiccant volume to exceed the predefined level. Likewise, minimum desiccant level sensors in the regeneration reservoir may trigger a stop in misting and the condensation/water-collection processes within the regeneration chamber when desiccant levels in the regeneration chamber reservoir fall below a predefined limit. There may, thus, be established one or more feedback loops which maintains an equilibrium of desiccant hydration levels between both chambers of a dehumidification and AWG system according to embodiments of the present invention.

Moisture extracted from the liquid desiccant in the regeneration/moisture-extraction assembly, for example using evaporation and condensation coils, may be collected and funneled towards a water collection chamber. This chamber interconnection arrangement enables the positioning of the regeneration section above the collection chamber, and as a result supports various advantages towards minimizing the size of the water generation system. For example, since according to embodiments of the present invention, desiccant regeneration and water collection is performed at a higher level than dehumidification, the present invention enables the generation of water from the vapor at a higher location which provides for the ability to use gravity for water distribution, thereby possibly eliminating the need for one or water more pumps.

### BRIEF DESCRIPTION OF THE FIGURES

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows a condensation type atmospheric water generator according to the prior art;

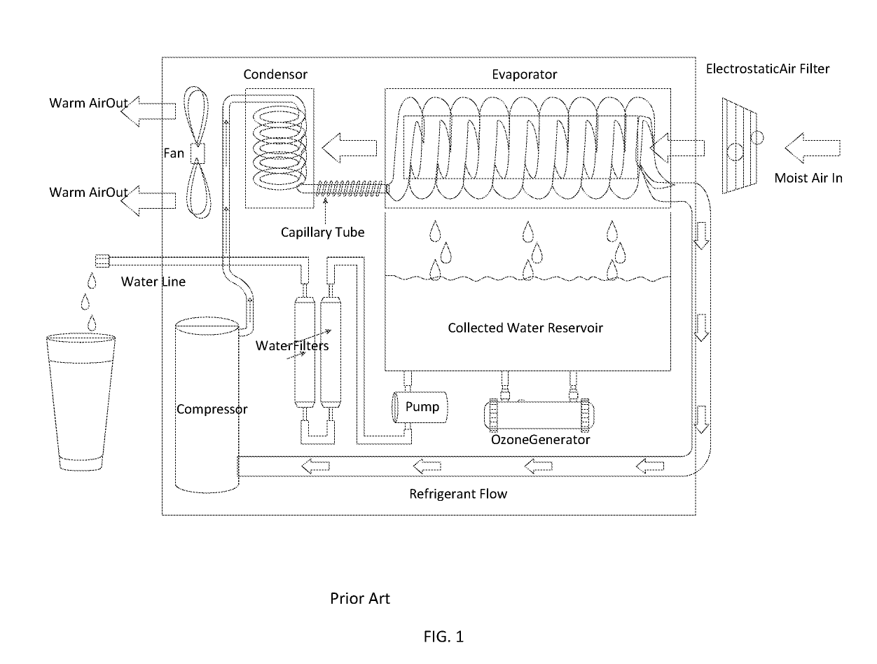

FIG. 2 shows an exemplary air dehumidifier and atmospheric water generator according to embodiments of the present invention; and

FIG. 3 shows a flow chart including the steps of an exemplary method of dehumidifying air and generating water from atmospheric humidity according to embodiments of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE FIGURES

In the following detailed description, numerous specific details are set forth in order to provide a thorough understanding of the invention. However, it will be understood by those skilled in the art that the present invention may be practiced without these specific details. In other instances, well-known methods, procedures, components and circuits have not been described in detail so as not to obscure the present invention.

Unless specifically stated otherwise, as apparent from the following discussions, it is appreciated that throughout the specification discussions utilizing terms such as “processing”, “computing”, “calculating”, “determining”, or the like, may refer to the action and/or processes of a computer or computing system, or similar electronic computing device, that manipulate and/or transform data represented as physical, such as electronic, quantities within the computing system's registers and/or memories into other data similarly represented as physical quantities within the computing system's memories, registers or other such information storage, transmission or display devices.

In addition, throughout the specification discussions utilizing terms such as “storing”, “hosting”, “caching”, “saving”, or the like, may refer to the action and/or processes of ‘writing’ and ‘keeping’ digital information on a computer or computing system, or similar electronic computing device, and may be interchangeably used. The term “plurality” may be used throughout the specification to describe two or more components, devices, elements, parameters and the like.

Some embodiments of the invention, for example, may take the form of an entirely hardware embodiment, an entirely software embodiment, or an embodiment including both hardware and software elements. Some embodiments may be implemented in software, which includes but is not limited to firmware, resident software, microcode, or the like.

Furthermore, some embodiments of the invention may take the form of a computer program product accessible from a computer-usable or computer-readable medium providing program code for use by or in connection with a computer or any instruction execution system. For example, a computer-usable or computer-readable medium may be or may include any apparatus that can contain, store, communicate, propagate, or transport the program for use by or in connection with the instruction execution system, apparatus, or device.

In some embodiments, the medium may be an electronic, magnetic, optical, electromagnetic, infrared, or semiconductor system (or apparatus or device) or a propagation medium. Some demonstrative examples of a computer-readable medium may include a semiconductor or solid-state memory, magnetic tape, a removable computer diskette, a random-access memory (RAM), a read-only memory (ROM), any composition and/or architecture of semiconductor based Non-Volatile Memory (NVM), any composition and/or architecture of biologically based Non-Volatile Memory (NVM), a rigid magnetic disk, and an optical disk. Some demonstrative examples of optical disks include compact disk—read only memory (CD-ROM), compact disk—read/write (CD-R/W), and DVD.

In some embodiments, a data processing system suitable for storing and/or executing program code may include at least one processor coupled directly or indirectly to memory elements, for example, through a system bus. The memory elements may include, for example, local memory employed during actual execution of the program code, bulk storage, and cache memories which may provide temporary storage of at least some program code in order to reduce the number of times code must be retrieved from bulk storage during execution.

According to embodiments, desiccant, solid or liquid, may be used to attract water vapor from air because of the difference in vapor pressure between the air and the surface of the desiccant solution. Dehumidification process is said to occur when the vapor pressure of the surface of the desiccant is less than that of air and continues until the desiccant reaches equilibrium with air. Desiccants can be regenerated at low temperature, from approximately 50° C. to 80° C. Thus, the regeneration process could be driven by heat sources with a relatively low temperature of approximately 70° C., such as electrical heaters, solar energy, waste heat, and geothermal power.

Desiccants can be classified into solid and liquid desiccant. Several types of solid materials can hold of water vapor; they are silicas, polymers, zeolites, aluminas, hydratable salts, and mixtures. Liquid desiccant types include: sodium chloride, calcium chloride, lithium chloride, lithium bromide, Tri-ethylene glycol, and a mixture of 50% calcium chloride and 50% lithium chloride. Liquid desiccants exhibit properties including low vapor pressure, low crystallization point, high density, low viscosity, and low regeneration temperature.

The present invention includes method, apparatuses, assemblies and systems for dehumidifying air and producing water from the moisture extracted from the air. According to embodiments, there was provided a desiccant regeneration chamber of an atmospheric water generator comprising a desiccant reservoir to hold hydrated desiccant received through a pumped line from a functionally associated moisture collection chamber. The regeneration camber may include a capillary type passive desiccant return line connected to an outlet of said desiccant reservoir of said regeneration chamber and configured to provide for desiccant viscosity dependent self-regulated desiccant flow from said desiccant reservoir of said regeneration chamber back to a desiccant reservoir in the functionally associated dehumidification chamber. The chamber may further comprise a misting assembly including a desiccant pump to pump hydrated desiccant from said regeneration chamber reservoir towards and through mist release heads. The chamber may further comprise a condensation coil positioned over a water collection pan within said regeneration chamber and adapted to convert humidity within the regeneration chamber air into water. The chamber may further comprise one or more air movers to move air within said regeneration chamber through mist generated by the misting assembly and towards said condensation coils. According to embodiments, the regeneration chamber is located at a higher level than the functionally associated moisture collection chamber.

According to embodiments of the present invention, the capillary type passive return line from the regeneration chamber to the moisture-collection/dehydration chamber may include one or more capillary tubes with a predefined channel diameter. The self-regulated flow rate of said one or more capillary tubes is directly related to a hydration level or percentage of the desiccant in said regeneration chamber reservoir which is also inversely related to a viscosity of the desiccant in said regeneration chamber reservoir.

The present invention may include methods for atmospheric water generation including receiving a hydrated desiccant at a desiccant regeneration reservoir through a pumped line from a functionally associated moisture collection chamber positioned below the regeneration reservoir. The method also includes at least partially dehydrating the received desiccant by extracting moisture from the desiccant, and returning via one or more capillary type desiccant return lines at least partially dehydrated desiccant to a desiccant reservoir in the functionally associated moisture collection chamber as part of a passive self-regulated desiccant return flow process, wherein the self-regulated desiccant return flow process may be defined by a selection of one or more configuration parameters of the one or more capillary type desiccant return lines. The one or more configuration parameters are selected from the group consisting of: (a) desiccant return line width, (b) desiccant return line length, (c) desiccant return line orientation/angle, (d) desiccant return line temperature, and (e) desiccant return line composition.

According to the method, extracting moisture from received desiccant may include transferring moisture from the hydrated desiccant to air moving towards a condensation coil. Transferring moisture to the air may include misting the hydrated desiccant to through the air.

According to embodiments, there may be provided an atmospheric water generation system comprising a moisture collection chamber including a desiccant hydration mechanism and a desiccant pumping mechanism. The system may include a regeneration chamber having: (a) a desiccant reservoir to hold hydrated desiccant received through a pumped line from said moisture collection chamber, and (b) a capillary type passive return line connected to an outlet of said desiccant reservoir of said regeneration chamber and configured to provide for self-regulated desiccant flow from said desiccant reservoir of said regeneration chamber back to a desiccant reservoir of said moisture collection chamber.

The system according to embodiments may further comprising a moisture transfer mechanism for transferring moisture from the hydrated desiccant to air within the regeneration chamber, wherein said moisture transfer mechanism may include a misting assembly including a desiccant pump to pump hydrated desiccant from said reservoir towards and through one or more mist release heads. The system may further comprise one or more air movers to move air within said regeneration chamber through mist generated by the misting assembly and towards a condensation coils.

The regeneration chamber may be located at a higher level than said moisture collection chamber. The capillary type passive return line may include one or more capillary tubes with a predefined channel diameter and wherein a self-regulated flow rate of said one or more capillary tubes may be directly related to a hydration level or percentage of the desiccant in said regeneration chamber reservoir, and wherein a self-regulated flow rate of said one or more capillary tubes may be inversely related to a viscosity of the desiccant in said regeneration chamber reservoir.

According to embodiments of the system, the moisture collection chamber may further comprise a desiccant hydration assembly, wherein the desiccant hydration assembly may include one or more desiccant pumps and one or more misting heads. The moisture collection chamber may further include one or more air movers to move moisture carrying air past misted desiccant, thereby hydrating the desiccant, which hydrated desiccant falls back into a reservoir of the moisture collection chamber.

According to some embodiments a liquid desiccant based air dehumidifying assembly, also referable to as a moisture collection assembly, may be positioned somewhere relatively lower than a corresponding desiccant regeneration assembly, which regeneration assembly may also be referred to as a water-extraction assembly. According to embodiments, liquid desiccant which absorbed moisture from air in the dehumidifying/moisture-collection assembly may be pumped up into the regeneration/water-extraction assembly. After being regenerated, desiccant from which moister/water was extracted in the regeneration assembly may return back to the dehumidifying/moisture-collection assembly by flowing down a return line, for example a capillary tube return line.

According to some embodiments, fluid flow of hydrated desiccant from the lower dehumidification chamber to the upper regeneration chamber may be triggered by an output signal from a desiccant volume or level sensor functionally associated with a desiccant reservoir of the dehumidification chamber. For example, once a desiccant level in the dehumidification chamber reservoir exceeds a certain level, desiccant flow from the lower chamber to the up chamber may be triggered. A desiccant level in the dehumidification chamber reservoir dropping below a certain level may trigger a cessation of desiccant flow to the regeneration chamber. A desiccant level in the dehumidification chamber reservoir dropping below a certain level may trigger an increase in desiccant hydration flows through dehydration chamber, wherein desiccant hydration flows may include: (a) airflow through the dehydration chamber; and (b) desiccant misting (e.g. spraying mist) through the air flowing in the dehydration chamber.

Hydrated or partially hydrated desiccant pumped into the regeneration chamber may be collected in a regeneration chamber desiccant reservoir. A misting mechanism within the regeneration chamber may spray hydrated desiccant mist through an air stream directed towards chilled condensation coils, which coils may be located over a water collection pan. An outlet of the pan may lead to a fresh water reservoir. As water is removed from the regeneration reservoir desiccant, it becomes dehydrated or regenerated and may be returned to the dehumidification chamber through a return channel or line, for example one or more capillary type tubes, lines or pipes, which may be referred to as capillary tubes.

A capillary tube according to embodiments of the present invention may have an inner channel diameter ranging from a fraction of a millimeter to several centimeters. The tuber may be oriented straight down, vertically, or at a diagonal. The tube's temperature may be regulated. And, the number of tubes used for any given system may depend on the overall desiccant volume used by the system.

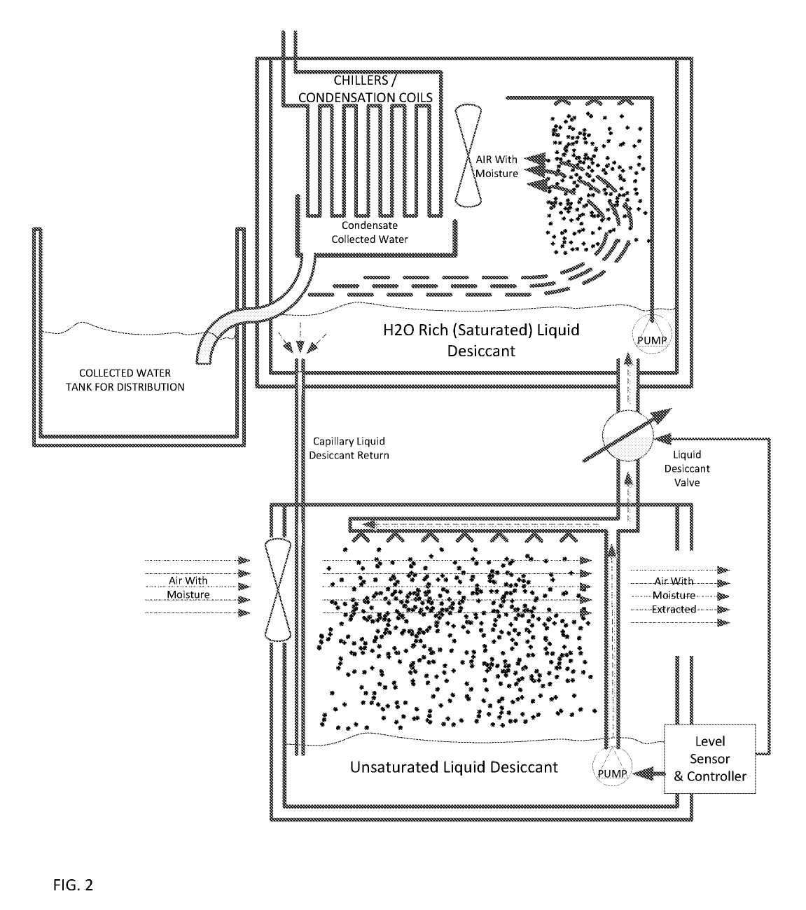

Turning now to FIG. 2, there is shown a diagram of a dehumidification and atmospheric water generation system according to embodiments of the present invention, wherein the lower chamber of the system is the moisture-collection or air-dehydration chamber and the upper most chamber is the desiccant regeneration chamber. Because the regeneration chamber is set above the collection chamber: (a) a pumping mechanism including a pump, a line and controllable valve are used to push hydrated or moisture saturated desiccant from a reservoir in the hydration chamber to the regeneration chamber, while (b) a capillary tube from the regeneration chamber reservoir to the collection chamber reservoir may return at least partially dehydrated desiccant to a desiccant reservoir of the collection chamber. Optionally, a micro diffusion chamber may be position in line with the collection chamber. Once the collection chamber is full, the capillary tube will stop the transfer of liquid to the process/collection side as the hydrostatic pressure of the regeneration liquid will be lower than the sum of pressures of the liquid cohesion to the capillary tube and the process liquid. Once the process liquid, hydrated desiccant, level goes down, the pressure reduces and the regeneration liquid will continue to flow to, optionally the micro chamber, and on to the process/dehydration chamber.

Functionally associated with the regeneration chamber is a water re-condensation chamber which is located above the regeneration chamber, and which allows for free fall of generated water to the collection or to the regeneration sumps. The water re-condensation chamber is merged into the regeneration chamber, while the collection mechanism separates between the water collected versus the liquid desiccant collected. The water chamber is above the process chamber.

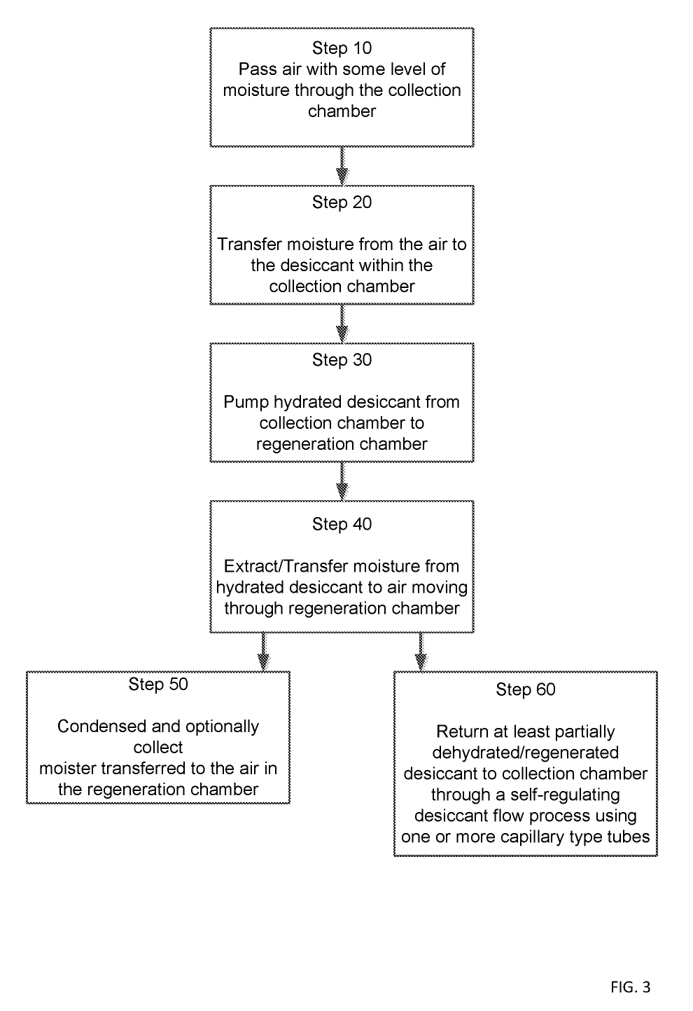

Operation of the system of FIG. 2 may be described in conjunction with the steps illustrated in the flowchart of FIG. 3. Air with some level of moisture may pass through the collection chamber (step 10) and a moisture extracting mechanism, such as desiccant misting, may be employed to transfer moisture from the air to the desiccant within the chamber (step 20). When a volume of hydrated desiccant in collection chamber desiccant reservoir reaches a predefined level, a control system may initiate pumping of the hydrated desiccant upward towards the regeneration chamber, for example by opening an electrically controllable valve connected to an existing pump (step 30).

A reservoir of the regeneration chamber may receive and collect the hydrated desiccant. The moisture transfer mechanism or assembly in the regeneration chamber may transfer moisture in the hydrated desiccant to air moving through the regeneration chamber (step 40), optionally towards a re-condensation assembly including a condensation coil and a water collection pan. Air movers, such as fans, may be integral or otherwise functionally associated with the regeneration chamber. Moister transferred to the air of the regeneration chamber may be condensed (step 50), and may be collected. At least partially dehydrated desiccant in the regeneration chamber reservoir may flow back to the collection chamber via a self-regulated capillary type desiccant return process which includes the use of one or more capillary type lines, tubes or pipes (step 60). As part of a self-regulating desiccant flow process according to embodiments of the present invention, in the event that the hydration level of the desiccant in the reservoir of the regeneration chamber falls below a predefined level, for example 18%, a corresponding rise in desiccant viscosity beyond threshold level, a level at which the desiccant can flow through the capillary type return tubes, will cause the flow of desiccant back to the collection chamber to slow and halt. Flow restarts once the viscosity of the desiccant drops, for example due to the addition of hydrated desiccant from the collection chamber.

Functions, operations, components and/or features described herein with reference to one or more embodiments, may be combined or otherwise utilized with one or more other functions, operations, components and/or features described herein with reference to one or more other embodiments, or vice versa. While certain features of the invention have been illustrated and described herein, many modifications, substitutions, changes, and equivalents will now occur to those skilled in the art. It is, therefore, to be understood that the appended claims are intended to cover all such modifications and changes as fall within the true spirit of the invention.

What is claimed:

1. A regeneration chamber of an atmospheric water generator comprising:
a desiccant reservoir to hold hydrated desiccant received through a pumped line from a functionally associated moisture collection chamber; and
a capillary type passive desiccant return line connected to an outlet of said desiccant reservoir of said regeneration chamber and configured to provide for desiccant viscosity dependent self-regulated desiccant flow from said desiccant reservoir of said regeneration chamber back to a desiccant reservoir in the functionally associated dehumidification chamber.

2. The chamber according to claim 1 and further comprising a misting assembly including a desiccant pump to pump hydrated desiccant from said regeneration chamber reservoir towards and through mist release heads.

3. The chamber according to claim 1 and further comprising a condensation coil positioned over a water collection pan within said regeneration chamber and adapted to convert humidity within the regeneration chamber air into water.

4. The chamber according to claim 2 and further comprising one or more air movers to move air within said regeneration chamber through mist generated by the misting assembly and towards said condensation coils.

5. The chamber according to claim 1, wherein said regeneration chamber is located at a higher level than the functionally associated moisture collection chamber.

6. The chamber according to claim 1, wherein said capillary type passive return line includes one or more capillary tubes with a predefined channel diameter and wherein a self-regulated flow rate of said one or more capillary tubes is directly related to a hydration level or percentage of the desiccant in said regeneration chamber reservoir.

7. The chamber according to claim 6, wherein said capillary type passive return line includes one or more capillary tubes with a predefined channel diameter and wherein a self-regulated flow rate of said one or more capillary tubes is inversely related to a viscosity of the desiccant in said regeneration chamber reservoir.

8. A method for atmospheric water generation comprising:
receiving a hydrated desiccant at a desiccant regeneration reservoir through a pumped line from a functionally associated moisture collection chamber positioned below the regeneration reservoir; and
at least partially dehydrating the received desiccant by extracting moisture from the desiccant;
returning via one or more capillary type desiccant return lines at least partially dehydrated desiccant to a desiccant reservoir in the functionally associated moisture collection chamber as part of a passive self-regulated desiccant return flow process.

9. The method according to claim 8, wherein extracting moisture from received desiccant includes transferring moisture from the hydrated desiccant to air moving towards a condensation coil.

10. The method according to claim 9, further comprising condensing moisture transferred to the air over a water collection pan.

11. The method according to claim 8, wherein the self-regulated desiccant return flow process is defined by a selection of one or more configuration parameters of the one or more capillary type desiccant return lines.

12. The method according to claim 11, wherein the one or more configuration parameters are selected from the group consisting of: (a) desiccant return line width, (b) desiccant return line length, (c) desiccant return line orientation, (d) desiccant return line temperature, and (e) desiccant return line composition.

13. The method according to claim 9, wherein transferring moisture to the air includes misting the hydrated desiccant to through the air.

14. The method according to claim 8, further comprising dehumidification of air via hydration of desiccant.

15. An atmospheric water generator system comprising:
a moisture collection chamber including a desiccant hydration mechanism and a desiccant pumping mechanism;
a regeneration chamber including: (a) a desiccant reservoir to hold hydrated desiccant received through a pumped line from said moisture collection chamber, and (b) a capillary type passive return line connected to an outlet of said desiccant reservoir of said regeneration chamber and configured to provide for self-regulated desiccant flow from said desiccant reservoir of said regeneration chamber back to a desiccant reservoir of said moisture collection chamber.

16. The system according to claim 15 and further comprising a moisture transfer mechanism for transferring moisture from the hydrated desiccant to air within the regeneration chamber.

17. The system according to claim 16, wherein said moisture transfer mechanism includes a misting assembly including a desiccant pump to pump hydrated desiccant from said reservoir towards and through one or more mist release heads.

18. The system according to claim 17 and further comprising one or more air movers to move air within said regeneration chamber through mist generated by the misting assembly and towards a condensation coils.

19. The system according to claim 15 wherein said regeneration chamber is located at a higher level than said moisture collection chamber.

20. The system according to claim 15, wherein said capillary type passive return line includes one or more capillary tubes with a predefined channel diameter and wherein a self-regulated flow rate of said one or more capillary tubes is directly related to a hydration level or percentage of the desiccant in said regeneration chamber reservoir.

21. The system according to claim 15, wherein said capillary type passive return line includes one or more capillary tubes with a predefined channel diameter and wherein a self-regulated flow rate of said one or more capillary tubes is inversely related to a viscosity of the desiccant in said regeneration chamber reservoir.

22. The system according to claim 15, wherein said moisture collection chamber further comprises a desiccant hydration assembly.

23. The system according to claim 22, wherein said desiccant hydration assembly comprises one or more desiccant pumps and one or more misting heads.

24. The system according to claim 23, wherein said moisture collection chamber further comprises one or more air movers to move moisture carrying air past misted desiccant.
